(19) United States
(12) Patent Application Publication
(10) Pub. No.: US 2025/0074104 A1
(43) Pub. Date: Mar. 6, 2025

(54) Plastic Egg For Art Projects

(71) Applicant: Kristen Nevin, Glen Burnie, MD (US)

(72) Inventor: Kristen Nevin, Glen Burnie, MD (US)

(21) Appl. No.: 18/243,081

(22) Filed: Sep. 6, 2023

(51) Int. Cl. B44D 3/12; B44D 2/00

(52) U.S. Cl. CPC B44D 3/12; B44D 2/00

(57) ABSTRACT

An art kit product wherein brittle plastic eggs are pre-filled with paint. The plastic shell is brittle enough to replicate the strength of a normal egg without the need to fill up a normal egg with paint. The art project eggs come pre-filled with paint which matches the color of the plastic egg on the outside.

### PRIOR ART

While there has been prior art such as EP 0,609,298 or U.S. Pat. No. 9,482,503 which deal with paintballs and paintball grenades, respectively. These objects are not designed for children's art projects. Then there is the traditional route of filling up actual eggs with paint, however, this also poses a problem.

### BACKGROUND OF THE INVENTION

While it is possible to fill up traditional eggs with various paints for an art project, this requires the user to either eat or waste an excessive number of eggs. The present subject matter remedies this issue.

### SUMMARY OF THE INVENTION

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

As described herein, the term “pivotally connected” shall be used to describe a situation wherein two or more identified objects are joined together in a manner that allows one or both of the objects to pivot, and/or rotate about or in relation to the other object in either a horizontal or vertical manner.

As described herein, the term “removably coupled” and derivatives thereof shall be used to describe a situation wherein two or more objects are joined together in a non-permanent manner so as to allow the same objects to be repeatedly joined and separated.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

The present subject matter comprises of an art kit product wherein brittle plastic eggs are pre-filled with paint. The plastic shell is brittle enough to replicate the strength of a normal egg without the need to fill up a normal egg with paint.

The plastic eggs for art projects will come pre-filled with paint which matches the color of the plastic egg on the outside. The present subject matter will also be contained in a specialized egg carton to prevent the paint filled eggs from cracking pre-maturely. The specialized egg carton will resemble that of an ordinary egg carton with an additional tray to catch paint that might leak.

The present subject matter will allow the user to throw their paint filled eggs at a canvas without having to worry about preparation work or wasting eggs.

In some embodiments the plastic eggs are not pre-filled so the user can select their own color and type of paint.

In some embodiments, the pre-filled plastic eggs have a plain white shell.

In other embodiments, the shape of the egg is a sphere instead of the traditional egg shape.

While several illustrative embodiments of the invention have been shown and described, numerous variations and alternative embodiments will occur to those skilled in the art. Such variations and alternative embodiments are contemplated and can be made without departing from the scope of the invention as defined in the appended claims.

### DESCRIPTION OF DRAWINGS

FIG. 1 shows a front view of a plastic egg wherein the user is able to fill the egg with the desired color of paint.

FIG. 2 shows a front view of a plastic egg wherein the egg is pre-filled with paint.

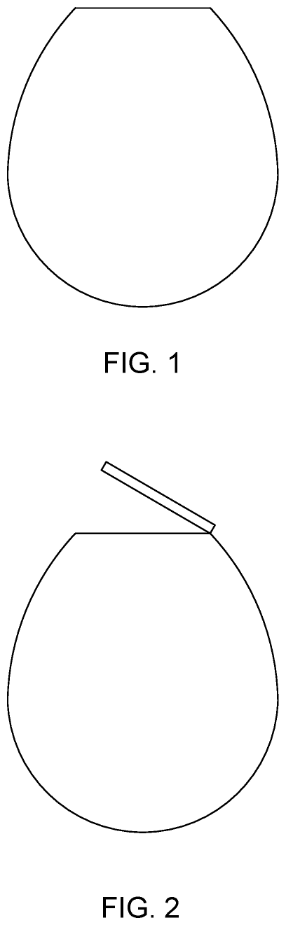

1. A plastic egg for art projects comprising a plurality of plastic eggs, paint, and a specialized carton.

2. The plastic egg for art projects comprising the plurality of plastic eggs, paint, and specialized carton as in claim 1, wherein the plastic eggs have the same level of brittleness as traditional eggs.

3. The plastic egg for art projects comprising the plurality of plastic eggs, paint, and specialized carton as in claim 1, wherein the paint is pre-filled into the plastic eggs.

4. The plastic egg for art projects comprising the plurality of plastic eggs, paint, and specialized carton as in claim 1, wherein the paint matches the color of the outside of the plastic egg.

5. The plastic egg for art projects comprising the plurality of plastic eggs, paint, and specialized carton as in claim 1, wherein the specialized carton resembles that of an ordinary egg carton with an additional tray to catch paint that might leak.

6. A method of manufacturing a plastic egg for art projects comprising a plurality of plastic eggs, paint, and a specialized carton.

7. The method of manufacturing the plastic egg for art projects comprising the plurality of plastic eggs, paint, and specialized carton as in claim 6, wherein the plastic eggs have the same level of brittleness as traditional eggs.

8. The method of manufacturing the plastic egg for art projects comprising the plurality of plastic eggs, paint, and specialized carton as in claim 6, wherein the paint is pre-filled into the plastic eggs.

9. The method of manufacturing the plastic egg for art projects comprising the plurality of plastic eggs, paint, and specialized carton as in claim 6, wherein the paint matches the color of the outside of the plastic egg.

10. The method of manufacturing the plastic egg for art projects comprising the plurality of plastic eggs, paint, and specialized carton as in claim 6, wherein the specialized carton resembles that of an ordinary egg carton with an additional tray to catch paint that might leak.
